(19) United States
(12) Patent Application Publication
(10) Pub. No.: US 2016/0298363 A1
(43) Pub. Date: Oct. 13, 2016

(54) METHOD FOR HANDLING MOTOR VEHICLE KEYS

(71) Applicant: David Earl LUSH, Burlington (CA)

(72) Inventor: David Earl LUSH, Burlington (CA)

(21) Appl. No.: 14/682,497

(22) Filed: Apr. 9, 2015

(51) Int. Cl. E05B 65/52; E05B 47/00; E05B 37/00

(52) U.S. Cl. CPC E05B 65/52; E05B 37/0048; E05B 47/00

(57) ABSTRACT

A method for handling a motor vehicle key used to service a motor vehicle comprises receiving a motor vehicle and a motor vehicle key for the motor vehicle and using the motor vehicle key to perform service on the motor vehicle. A combination-controlled lockbox is made accessible to an authorized motor vehicle retriever for the motor vehicle by setting a combination for the lockbox and, after performing service on the motor vehicle, the motor vehicle key is secured in the lockbox. After securing the motor vehicle key in the lockbox, the motor vehicle key is available to the authorized motor vehicle retriever for the motor vehicle by use of the combination. The combination may be communicated to the authorized motor vehicle retriever, or may be provided by the authorized motor vehicle retriever. The combination can be set before or after the motor vehicle key is secured in the lockbox.

### TECHNICAL FIELD

The present invention relates to service of motor vehicles, and more particularly to handling of motor vehicle keys during such service.

### BACKGROUND

Motor vehicles frequently require service, including routine maintenance, repairs, cleaning such as interior and exterior detailing, among other types of service. In many cases, the nature of the service requires that the motor vehicle key be given to the service provider. While the service can sometimes be performed “while you wait”, often the required service takes too long for waiting to be convenient. The facilities that perform service on motor vehicles, particularly automobile dealerships, have made efforts to meet this problem by providing courtesy shuttles and “loaner” cars. However, these amenities entail increased cost, and still require that an individual attend at the service provider's facility during business hours to pick up the motor vehicle key and retrieve the motor vehicle. The result is either inconvenience for the individual picking up the motor vehicle, increased cost to the service provider to extend business hours, or both.

### SUMMARY

In one aspect, a method for handling a motor vehicle key used to service a motor vehicle comprises receiving a motor vehicle and a motor vehicle key for the motor vehicle and using the motor vehicle key to perform service on the motor vehicle. A combination-controlled lockbox is made accessible to an authorized motor vehicle retriever for the motor vehicle by setting a combination for the lockbox and, after performing service on the motor vehicle, the motor vehicle key is secured in the lockbox. After securing the motor vehicle key in the lockbox, the motor vehicle key is available to the authorized motor vehicle retriever for the motor vehicle by use of the combination. The combination may be communicated to the authorized motor vehicle retriever, or may be provided by the authorized motor vehicle retriever. The combination can be set before or after the motor vehicle key is secured in the lockbox.

In one aspect, a method for transferring a motor vehicle key to an authorized motor vehicle retriever comprises a step of (a) placing the motor vehicle key inside a compartment of a lockable container. The lockable container has, for each compartment, a closure movable between a closed configuration obstructing public access to the compartment and an open configuration permitting public access to the compartment, a locking mechanism acting between the container and the closure for selectively locking the closure in the closed configuration, and a combination-activated control mechanism coupled to the locking mechanism for controlling locking and unlocking thereof. The control mechanism is arranged to unlock the locking mechanism in response to entry of a correct combination and to maintain the locking mechanism locked in response to entry of an incorrect combination, and is selectively reconfigurable with a plurality of correct combinations. The method comprises further steps of (b) using the locking mechanism to lock the closure in the closed configuration, and (c) configuring the control mechanism with a new correct combination. At least step (a) is carried out other than by the authorized motor vehicle retriever, and steps (a), (b) and (c) may be carried out in any order.

The method may further comprise a step of (d) communicating the new correct combination to the authorized motor vehicle retriever, either before or after any one of steps (a), (b) and (c), with step (d) being carried out other than the by the authorized motor vehicle retriever.

Communicating the new combination to the authorized motor vehicle retriever may be carried out by at least one of text message, e-mail message, telephone, non-electronic written communication and presentation on a website.

In some embodiments, the control mechanism may be a mechanical control mechanism; in other embodiments, the control mechanism may be an electronic control mechanism.

In certain embodiments, the compartment is one of a plurality of individually lockable compartments in a locker system, and configuring the respective control mechanism with a new combination may be carried out using a central controller coupled to the locker system. In some embodiments, the central controller may be physically integrated with the locker system; in other embodiments, the central controller may be physically remote from the locker system.

The method may further comprise, prior to steps (a), (b) and (c), receiving the motor vehicle key in a secure drop-box forming part of the locker system.

In some embodiments, the motor vehicle key is placed inside the compartment through a private access opening.

In another aspect, a method for making a motor vehicle key available to an authorized motor vehicle retriever comprises the steps of (i) securing the motor vehicle key in a lockbox and (ii) setting a combination for opening the lockbox, with at least step (i) being carried out other than by the authorized motor vehicle retriever. Steps (i) and (ii) may be performed in any order.

The method may further comprise a step of (iii) communicating the combination to the authorized motor vehicle retriever, either before or after any one of steps (i) and (ii), with step (iii) being carried out other than by the authorized motor vehicle retriever.

Communicating the combination to the authorized motor vehicle retriever may be carried out by at least one of text message, e-mail message, telephone, non-electronic written communication and presentation on a website.

In some embodiments, the lockbox may be a mechanically-controlled lockbox; in other embodiments, the lockbox may be an electronically-controlled lockbox.

In certain embodiments, the lockbox may be one of a plurality of lockboxes in a locker system, and setting a combination for opening the lockbox may be carried out using a central controller coupled to the locker system. In some embodiments, the central controller may be physically integrated with the locker system; in other embodiments, the central controller may be physically remote from the locker system.

The method may further comprise, prior to steps (i) and (ii), receiving the motor vehicle key in a secure drop-box forming part of the locker system.

In some embodiments, securing the motor vehicle key in the lockbox comprises placing the motor vehicle key inside the lockbox through a private access opening.

### BRIEF DESCRIPTION OF THE DRAWINGS

These and other features will become more apparent from the following description in which reference is made to the appended drawings wherein:

FIG. 1 is a flow chart showing an exemplary method for handling a motor vehicle key used to service a motor vehicle;

FIG. 2 is a schematic representation showing an individual placing a motor vehicle key inside a compartment of a lockable container and closing a closure thereof;

FIG. 3 is a schematic representation showing an individual using a locking mechanism of the lockable container of FIG. 2 to lock the closure in the closed configuration;

FIG. 4 and FIG. 4A are schematic representations showing an individual configuring a control mechanism of the lockable container of FIG. 2 with a new combination;

FIG. 5 is a schematic representation showing an individual communicating a new combination to an authorized motor vehicle retriever;

FIG. 6 is a schematic representation showing an individual placing a motor vehicle key inside a compartment of a lockable container through a private access opening;

FIG. 7 is a schematic representation showing an exemplary locker system having a plurality of compartments and respective closures with associated locking mechanisms and combination-activated control mechanisms and having a central controller coupled to the combination-activated control mechanisms, with the central controller being physically integrated with the locker system;

FIG. 8 is a schematic representation showing an exemplary locker system having a plurality of compartments and respective closures with associated locking mechanisms and combination-activated control mechanisms and having a central controller coupled to the combination-activated control mechanisms, with the central controller being physically remote from the locker system;

FIG. 9A is a first perspective view showing an exemplary locker system having a plurality of compartments and respective closures with associated locking mechanisms and combination-activated control mechanisms and showing a door of a secure drop-box slightly ajar; and

FIG. 9B is a second perspective view of the locker system of FIG. 9A showing the door of the secure drop-box open.

### DETAILED DESCRIPTION

In order to properly understand the description and claims, it is important to understand the particular meanings ascribed to particular terms used herein.

As used herein, the term “motor vehicle key” refers to any discrete device designed to interact with a motor vehicle to enable activation of the motor vehicle engine and permit the motor vehicle to be driven by an individual in possession of the device while activation of the motor vehicle engine and driving of the motor vehicle by a person not in possession of the device is inhibited, whether such device is now known or hereafter developed. As such, the term “motor vehicle key” is not limited to a conventional mechanical key having a bow and cut blade that interacts mechanically with a lock cylinder. The term “motor vehicle key” also includes mechanical keys having transponders that interact with an engine control unit of a motor vehicle, as well as so-called “smart keys” which rely primarily on wireless transmission systems to enable and disable locks, ignition (for example by pushbutton start) and driving. Examples of “smart key” systems include those offered by Nissan Jidosha Kabushiki Kaisha (trading as Nissan Motor Co., Ltd.) under the trademark Nissan Intelligent Key® and by Chrysler (FCA US LLC) under the trademark Keyless Enter-N-Go™. The term “motor vehicle key” also includes sets of devices that cooperate to perform the aforementioned functions.

As used herein, the term “motor vehicle” refers to any steerable motorized motor vehicle controlled by an on-board human operator. The term “motorized” refers to an engine driven by a source other than human or animal muscular power, and therefore includes internal combustion engines (both diesel and gasoline), electric engines, and hybrid engines. As such, the term “motor vehicle” includes, but is not limited to, cars, trucks, vans, SUVs, motorcycles, motorized tricycles, all-terrain motor vehicles and snowmobiles, as well as motorized boats and personal watercraft.

The term “authorized motor vehicle retriever” refers to an individual who is the owner of a particular motor vehicle, or is authorized by the owner, or by a delegate of the owner, to retrieve a motor vehicle from a location where it is being stored and permanently remove it to another geographic location remote from the geographic location where it is being stored. Accordingly, an “authorized motor vehicle retriever” may or may not be the owner of the motor vehicle. In one example, an individual may own a car that has not been leased to another, and is hence an authorized motor vehicle retriever. That individual could in turn authorize another individual, such as a spouse or a friend, or the individual's child who is of driving age, to retrieve the car, and the authorized spouse, friend or child would be an authorized motor vehicle retriever for that car. In another example, where an individual is leasing a car on a long-term lease, the lessor, although the owner, would generally not be an authorized motor vehicle retriever because while the lessor is the owner, the lessor has contractually relinquished possessory rights to the lessee. Conversely, the lessee, although not the legal owner of the vehicle, would be an authorized motor vehicle retriever. Furthermore, the lessee, as a delegate of the lessor (the owner), could in turn authorize another individual, such as a spouse or a friend, or the individual's child who is of driving age, to retrieve the car, and the authorized spouse, friend or child would be an authorized motor vehicle retriever for that car. It is important to note that the term “authorized motor vehicle retriever” does not include an individual whose authorization to possess and operate the motor vehicle is constrained by an obligation to return the motor vehicle to the location where it is being stored. In this regard, examples of locations where a motor vehicle may be stored include a dealership or mechanic's shop where the motor vehicle is being serviced or repaired, and the personnel may be authorized to perform a test drive in order to diagnose a mechanical problem. Those personnel, although authorized to possess and operate the motor vehicle for that limited purpose, are not considered to be “authorized motor vehicle retrievers” as that term is used herein. Even though they are authorized to remove the motor vehicle from the geographic location where it is being stored, they are only authorized to remove it temporarily and for a limited purpose, and are obligated to return the motor vehicle to the geographic location where it is being stored.

The term “combination”, as used herein, encompasses any kind of access code, including without limitation a pictorial sequence, a numeric sequence, an alphabetic sequence or an alphanumeric sequence, including a password or passphrase.

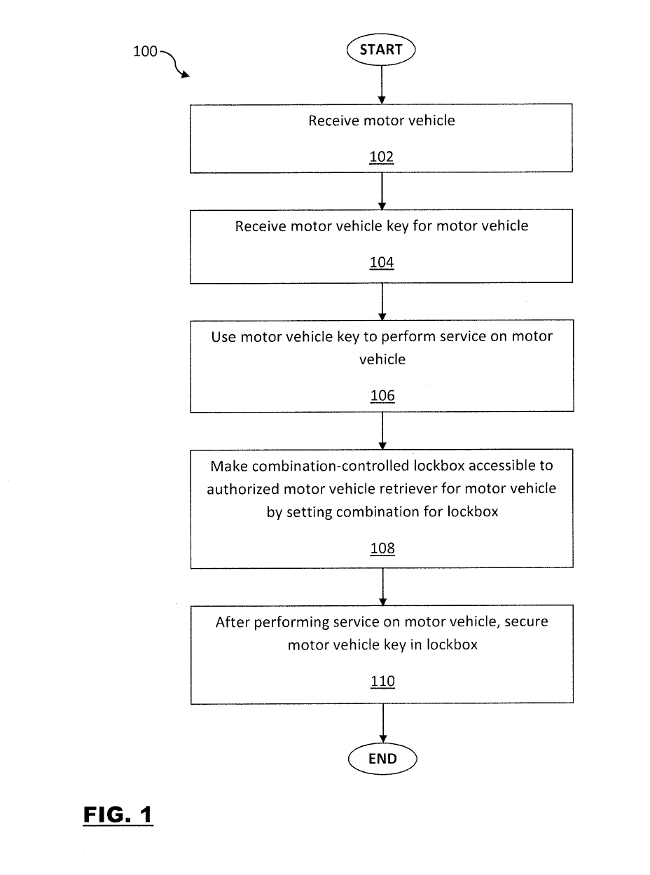

Reference is now made to FIG. 1, which is a flow chart showing an exemplary method 100 for handling a motor vehicle key used to service a motor vehicle. The method 100 would typically be carried out by an organization that performs service on motor vehicles for which possession of the key is required. Examples include motor vehicle dealerships, mechanic shops, and vehicle detailing services.

At step 102, a motor vehicle is received and at step 104, a motor vehicle key for the motor vehicle is received. Steps 102 and 104 may occur in any order or substantially simultaneously. For example, the motor vehicle may be parked on site, and the motor vehicle key may be handed to a staff member, or placed in a secure drop-box. Alternatively, the motor vehicle, while still running, may be turned over to a staff member. At step 106, the motor vehicle key is used to perform service on the motor vehicle. For example, the motor vehicle key may be used to drive the motor vehicle from a parking lot to a service bay. At step 108, a combination-controlled lockbox is made accessible to an authorized motor vehicle retriever for the motor vehicle by setting a combination for the lockbox. At step 110, which is carried out after performing service on the motor vehicle, the motor vehicle key is secured in the lockbox in such a way that, after securing the motor vehicle key in the lockbox, the motor vehicle key is available to the authorized motor vehicle retriever for the motor vehicle by use of the combination. As will be explained in more detail below, step 110 can be carried in a variety of ways and, depending on the manner in which step 108 is performed, step 108 can be carried out at any stage in the method 100, either before or after any other step. For example, step 108 can be carried out either before or after step 110.

In one type of implementation of the method 100, the combination-controlled lockbox is made accessible to the authorized motor vehicle retriever for the motor vehicle by setting the combination for the lockbox to a value provided by the authorized motor vehicle retriever. In another type of implementation of the method 100, the combination-controlled lockbox is made accessible to the authorized motor vehicle retriever by communicating the combination to the authorized motor vehicle retriever.

Various exemplary implementations of the method will now be described in greater detail.

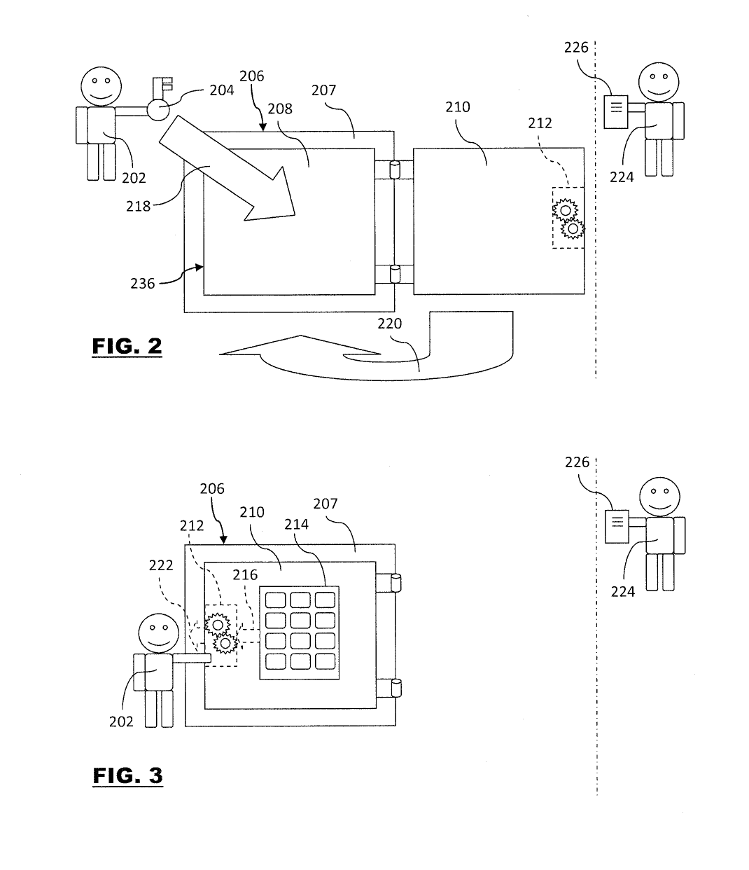

As shown in FIGS. 2 and 3, an individual 202 holds a motor vehicle key 204, and is physically proximate to a lockbox 206, that is, close enough to the lockbox 206 to place the motor vehicle key 204 inside the lockbox 206. Although the motor vehicle key 204 is shown schematically as a mechanical key, this is merely for purposes of illustration and should not derogate from the meaning of the term “motor vehicle key” as set out above.

In the exemplary embodiment shown schematically in FIGS. 2 to 3, the lockbox 206 comprises a container 207 having a compartment 208 and a closure 210. The closure 210 is movable between an open configuration permitting public access to the interior of the compartment 208, as shown in FIG. 2, and a closed configuration obstructing public access to the compartment 208, as shown in FIG. 3. As can be seen in FIG. 3, in the closed configuration, the closure 210 covers a public access opening 236 into the interior of the compartment 208. Although the closure 210 is shown in the form of a hinged door for purposes of illustration, the closure may take other forms, for example a sliding door or a rotating door.

The container 207 further comprises a locking mechanism 212 acting between the container 207 and the closure 210. The locking mechanism 212 is adapted to selectively lock the closure 210 in the closed configuration, and hence the container 207 is lockable. As best seen in FIG. 3, a combination-activated control mechanism 214 is coupled to the locking mechanism 212, shown schematically by arrow 216, for controlling locking and unlocking of the locking mechanism 212. The control mechanism 214 is arranged to selectively lock the locking mechanism 212, and to unlock the locking mechanism 212 in response to entry of a correct combination, and the control mechanism 214 is selectively reconfigurable with a plurality of correct combinations. Of course, the control mechanism 214 will not unlock the locking mechanism 212 in response to entry of an incorrect combination. Although the control mechanism 214 is shown schematically as a numerical keypad, this is merely for purposes of illustration and should not derogate from the meaning of the term “combination” as set out above. Similarly, although the locking mechanism 212 is shown schematically as a mechanical locking mechanism this is also merely for purposes of illustration. The locking mechanism 212 and the control mechanism 214 may be mechanical, electronic or electromechanical so long as the control mechanism 214 is arranged to unlock the locking mechanism 212 in response to entry of a correct combination and can be selectively reconfigured with different correct combinations. The term “electronic”, as used in this context, includes conventional purpose-build electronic circuits, programmable computing devices, and suitable combinations thereof. Thus, the lockbox 206 may be of any suitable type so long as it performs the required functions.

Referring specifically to FIGS. 2 and 3, in the exemplary illustrated implementation of the method 100, an individual 202 secures the motor vehicle key 204 in the lockbox 206 by placing the motor vehicle key 204 inside the compartment 208, as shown by arrow 218 in FIG. 2, closing the closure 210, as shown by arrow 220 in FIG. 2, and then using the locking mechanism 212 to lock the closure 210 in the closed configuration, as shown by arrow 222 in FIG. 3. Thus, FIGS. 2 and 3 show the individual 202 securing the motor vehicle key 204 in the lockbox 206. Depending on the particular embodiment of the lockbox 206, the individual 202 may use the locking mechanism 212 to lock the closure 210 in the closed configuration by interacting with the locking mechanism 212 as shown in FIG. 3, or with the control mechanism 214, either directly or remotely.

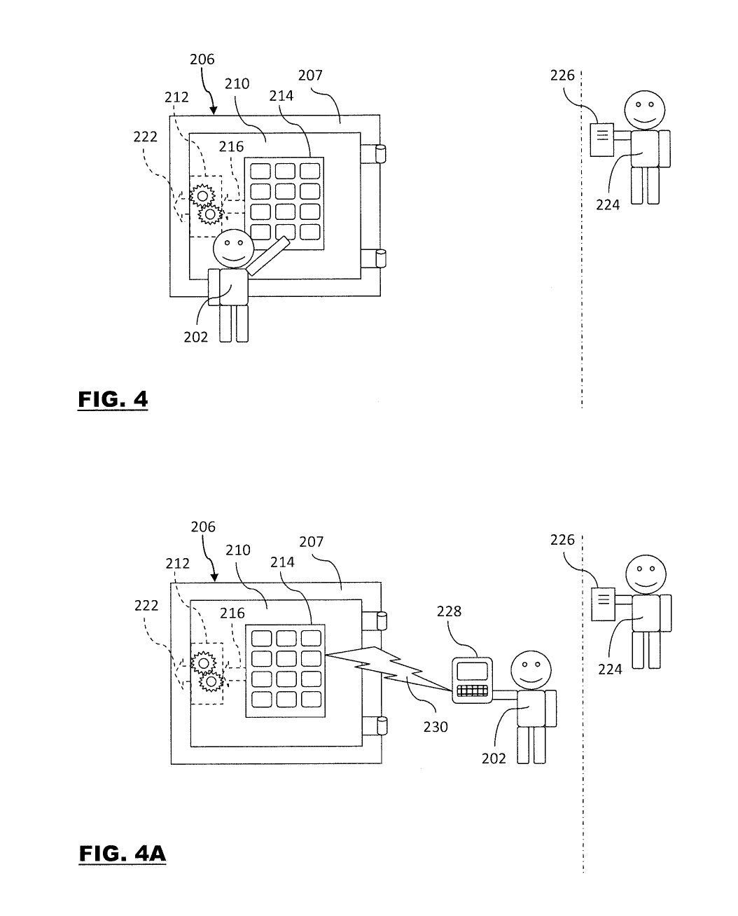

As shown in FIG. 4, the individual 202 sets a combination for opening the lockbox 206 by configuring the control mechanism 214 with a new correct combination. In the exemplary implementation shown in FIG. 4, the individual configures the control mechanism 214 with a new correct combination by interacting directly with the control mechanism 214. For example, the lockbox 206 may be a mechanical combination safe with a resettable combination, such as the “AccessPoint TouchPoint Lock with Faceplate” (Model No. 001827) offered by Kidde, a division of United Technologies Corporation, having an address at 1 Financial Plaza, Hartford, Conn. U.S.A. 06101. Alternatively, the lockbox 206 may be a programmable electronic safe of the type commonly used in hotel rooms, such as the LS-19EPL model offered by LockState, having an address at 2325 S. Colorado Blvd., Suite 400, Denver, Colo. 80222 U.S.A. or the MHRC 916E model offered by Mesa Safe Company, having an address at 337 W. Freedom Ave., Orange, Calif. 92865 U.S.A. In another exemplary implementation, as shown in FIG. 3A, the individual 202 may configure the control mechanism 214 with a new correct combination by interacting remotely with the control mechanism 214. FIG. 4A shows an individual 202 using a computing device 228 to send an electronic communication 230 to the control mechanism 214 to configure the control mechanism 214 with a new correct combination. The communication 230 may comprise one or more signals, which may be wired or wireless and may traverse one or more networks.

The authorized motor vehicle retriever is indicated by reference numeral 224 in FIGS. 2 to 4A, and is shown holding a receipt 226 relating to the relevant motor vehicle, for example a work order or cost estimate, to distinguish the authorized motor vehicle retriever 224 from the individual 202. Importantly, the individual 202 who secures the motor vehicle key 204 in the lockbox 206 after service has been performed is an individual other than the authorized motor vehicle retriever 224. In certain preferred embodiments, the individual 202 who sets a combination for opening the lockbox 206 is also an individual other than the authorized motor vehicle retriever 224. In cases where the individual 202 who secures the motor vehicle key 204 in the lockbox 206 is different from the individual 202 who sets a combination for opening the lockbox 206, each such individual 202 may be an individual other than authorized motor vehicle retriever 224. Thus, in certain preferred embodiments, the individual(s) who secure the motor vehicle key 204 in the lockbox 206 and set the combination for opening the lockbox 206 represent a first set of individuals (where there is a single individual this will be a set of one), and the authorized motor vehicle retriever 224 is an individual who is outside of the first set of individuals. In some implementations, the authorized motor vehicle retriever 224 may be at a location that is geographically remote from the location of the service facility when the motor vehicle key 204 is secured in the lockbox 206 and/or when the combination is set for opening the lockbox 206; this geographic remoteness is shown schematically by the dash-dot-dash line in FIGS. 2 to 4A.

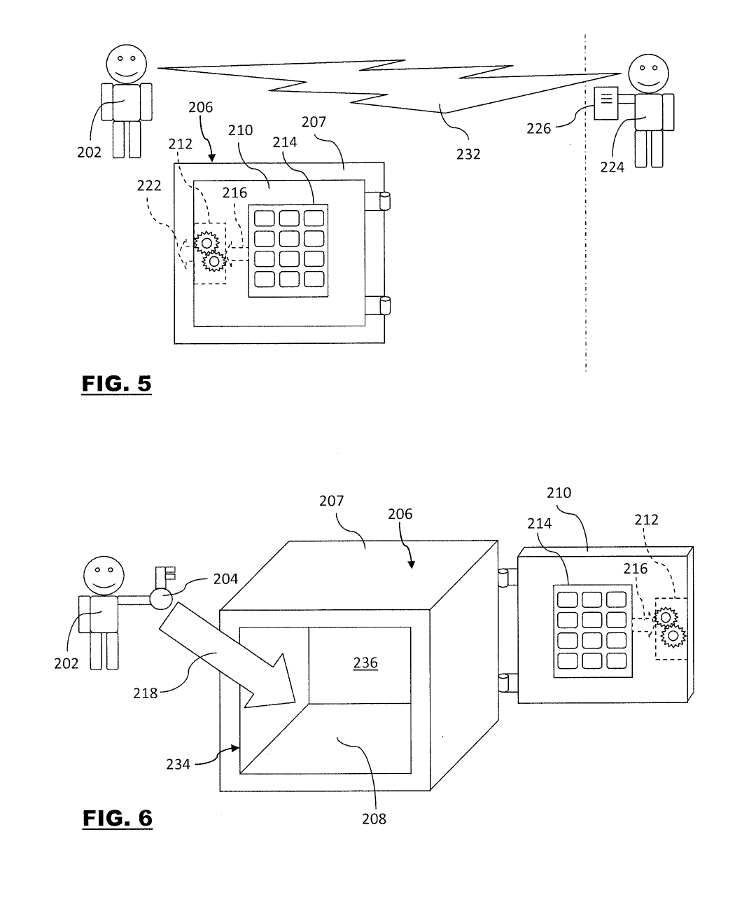

FIG. 5 shows an optional additional step in the exemplary method for making a motor vehicle key available to an authorized motor vehicle retriever. In particular, FIG. 5 shows an individual 202 communicating the new correct combination to the authorized motor vehicle retriever 224 via a communication 232. The individual 202 may be the same or different from the individual(s) securing the motor vehicle key 204 in the lockbox 206 and setting the combination for opening the lockbox 206; the individual who communicates the new correct combination would be considered part of the first set of individuals. Thus, the individual 202 who communicates the new correct combination is an individual other than the authorized motor vehicle retriever 224. In some implementations, the authorized motor vehicle retriever 224 may be at a location that is geographically remote from the location of the service facility when the communication 232 is made; this geographic remoteness is shown schematically by the dash-dot-dash line in FIG. 5.

The communication 232 is shown schematically in FIG. 5, and may take many forms including written and verbal; preferably communication 232 of the new combination to the authorized motor vehicle retriever is carried out by one or more of text message such as an SMS (Short Message Service) message or iMessage, an e-mail message, a telephone communication, a non-electronic written communication and/or presentation on a website. In one embodiment, the individual 202 may send a text message and/or e-mail message to the authorized motor vehicle retriever 224 to notify them that the service is complete and the text message and/or e-mail message may include the new correct combination. In another embodiment, the individual 202 may telephone the authorized motor vehicle retriever 224 to notify them that the service is complete and also communicate the new correct combination during that telephone call. In a further embodiment, for example where a customer has a personal account on an access-controlled portion of a website, the individual 202 may communicate the new correct combination by posting the combination on the access-controlled portion of the website. The foregoing types of communication may also be automated. In yet another embodiment, the individual 202 may write or print the combination on a piece of paper which can be given to the authorized motor vehicle retriever 224 when the motor vehicle is delivered.

With respect to the latter embodiment, it should be noted that communication 232 of the combination occurs before setting the combination for opening the lockbox 206. In this embodiment, the communication 232 would inform the authorized motor vehicle retriever 224 of the combination that an individual 202 intends to set. Moreover, as noted above, communicating the new correct combination to the authorized motor vehicle retriever 224 is optional. In some implementations, it may be the authorized motor vehicle retriever 224 who communicates the combination that is to be used to open the lockbox. In one such implementation, where a customer has a personal account on an access-controlled portion of a website, an authorized motor vehicle retriever 224 could use that website interface to communicate the combination that is to be used to open the lockbox 206, and the individual 202 may use that combination when configuring the control mechanism 214 with a new correct combination, or configuring the control mechanism 214 with a new correct combination may be an automated response. In another example, when dropping the motor vehicle off for service, an authorized motor vehicle retriever 224 could communicate a desired combination verbally or in writing when dropping off the motor vehicle. In one particular example, an authorized motor vehicle retriever 224 could park the motor vehicle at a drop-off location, lock the motor vehicle, write the desired combination on a form attached to the motor vehicle key 204, and place the form and motor vehicle key 206 in a secure lock box.

Not only may communication 232 of the combination occur before setting the combination for opening the lockbox 206, the steps of the method may be performed in any order that is suitable for the particular manner in which the method is to be implemented. For example, the combination may be set either before or after placing the motor vehicle key 204 inside the compartment 208, and closing 220 the closure 210 and using the locking mechanism 212 to lock the closure 210 in the closed configuration may similarly occur before or after setting the combination.

In certain particular embodiments, closing 220 the closure 210 and using the locking mechanism 212 to lock the closure 210 in the closed configuration may occur before placing the motor vehicle key 204 inside the compartment 208. Reference is now made to FIG. 6, which shows an individual 202 placing a motor vehicle key 204 inside the compartment 208 through a private access opening 234. For example, the private access opening 234 and the public access opening 236 may be opposed to one another, with the private access opening 234 exposing the compartment 208 to a building interior and the public access opening 234 exposing the compartment 208 to a building exterior. Thus, facility staff can place a motor vehicle key 204 inside the compartment 208 through a private access opening 234 from inside of the building, and the authorized motor vehicle retriever 224 can retrieve the motor vehicle key 204 through the public access opening 236. A second closure may optionally be provided to cover the private access opening 234; such a second closure may optionally be lockable in a closed configuration.

In cases where the compartment has both a private access opening 234 and a public access opening 236, it is possible for the authorized motor vehicle retriever 224 to use the locking mechanism 212 to lock the closure 210 in the closed configuration and set a combination for opening the lockbox 206 by configuring the control mechanism 214 with a new correct combination. For example, where a programmable electronic safe similar to the type commonly used in hotel rooms is equipped with a private access opening 234, an authorized motor vehicle retriever 224 could drop off the motor vehicle key 204 by placing it in the compartment 208, closing the closure 210 and programming a combination to lock the locking mechanism 212. Facility staff can then retrieve the motor vehicle key 204 through the private access opening 234 to perform service on the motor vehicle and, after completing the service, return the motor vehicle key 204 to the compartment 208 through the private access opening 234. The authorized motor vehicle retriever 224 can then use the previously programmed combination to unlock the locking mechanism 212 and access the compartment 208 to retrieve the motor vehicle key 204.

The method described herein for making a motor vehicle key 204 available to an authorized motor vehicle retriever facilitates retrieval of those vehicles by an authorized motor vehicle retriever from a facility which stores motor vehicles after servicing them and needs the motor vehicle key 204 to perform the service. Examples include a dealership, a mechanic's shop and a detailing service. The motor vehicle is dropped off, and the motor vehicle key 204 can be left with the staff of the facility so that the service can be performed. After completion of the service, the motor vehicle key 204 can be secured in the lockbox 206 for later retrieval by the authorized motor vehicle retriever 224. Such retrieval can occur without the authorized motor vehicle retriever 224 needing to interact with facility staff, since the authorized motor vehicle retriever 224 will use the combination to open the lockbox 206 and access the motor vehicle key 204. Moreover, where at least the closure 210 and public access opening 236 are positioned in a part of the facility that is accessible by the public after business hours, the facility does not need to be open when the authorized motor vehicle retriever 224 retrieves the motor vehicle key 204, which can then be used to retrieve the motor vehicle. For example, the lockbox 206, or at least the closure 210 and public access opening 236 thereof, may be positioned in a vestibule of a building where, after business hours, the outer door is unlocked but the inner door is locked. Alternatively, the lockbox 206 may be embedded in or otherwise secured to an exterior building wall, with at least the closure 210 and public access opening 236 accessible by persons outside the building. Where portions of the lockbox 206 will be exposed to the elements, they should of course be suitably weatherized.

Moreover, it is within the contemplation of the present disclosure that the motor vehicle key 204 may be placed in a compartment that is one of a plurality of individually lockable compartments, i.e. lockboxes, in a locker system. For example, a monolithic locker system may include a plurality of compartments and respective closures with associated locking mechanisms and combination-activated control mechanisms, with each compartment, closure, locking mechanism and combination-activated control mechanism together defining a lockbox. Alternatively, a plurality of individual lockboxes may be secured to one another or otherwise assembled together to form a locker system. In such embodiments, setting a combination for the respective lockbox by configuring the respective control mechanism with a new combination may be carried out using a central controller coupled to the locker system.

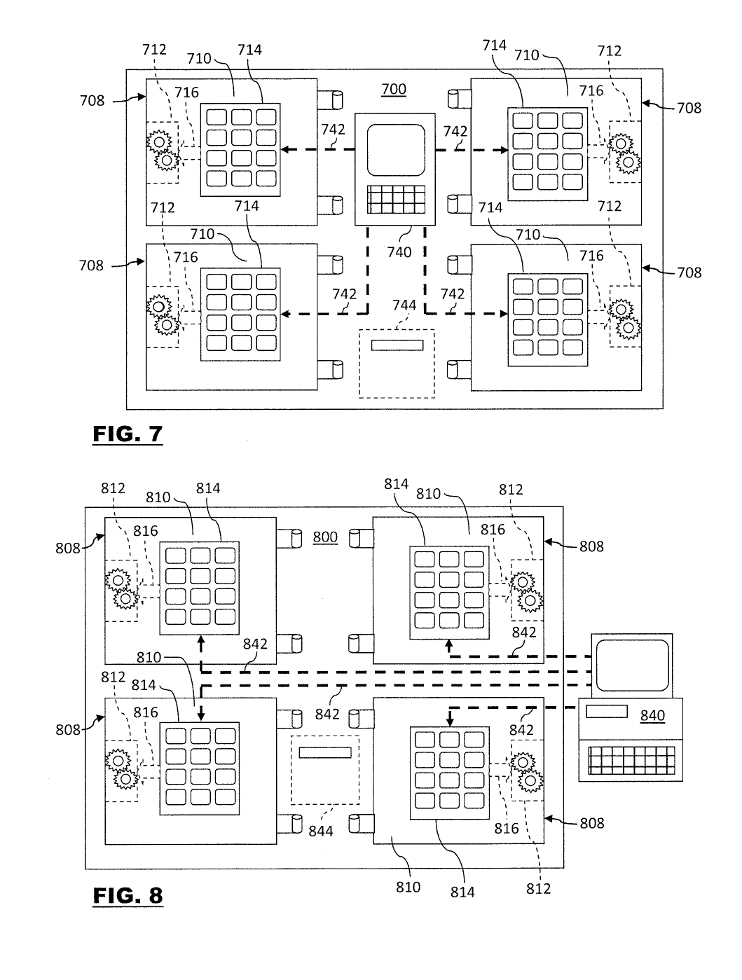

FIGS. 7 and 8 show, respectively, locker systems 700, 800 each having a plurality of compartments 708, 808 and respective closures 710, 810 with associated locking mechanisms 712, 812 and combination-activated control mechanisms 714, 814. Coupling of the combination-activated control mechanisms 714, 814 to the respective locking mechanisms 712, 812 is shown schematically by arrows 716, 816. Each locker system 700, 800 is associated with a respective central controller 740, 840 coupled to the combination-activated control mechanisms 714, 814 for changing the correct combination thereof, as shown by arrows 742, 842. The locker system 700 shown in FIG. 7 has a central controller 740 that is physically integrated with the locker system 700, for example by physical integration into the structure of the locker system 700. The locker system 800 shown in FIG. 8 is associated with a central controller 840 that is physically remote from the locker system 800, as shown schematically by the dot-dash-dot line. The central controller 800 may be a suitably programmed computer, as shown in FIG. 8, which may be located in an office at the location where the motor vehicle is being stored, or may be located elsewhere. For example, in an embodiment where a customer has a personal account on an access-controlled portion of a website, the central controller 840 may be a server associated with that website and coupled to the locker system 800 via one or more networks. In such an embodiment, the authorized motor vehicle retriever 224 could use the website interface to communicate the combination to the central controller 840, which in turn configures the relevant combination-activated control mechanisms 814. Thus, it is to be understood that in some implementations, using the locking mechanism to lock the closure in the closed configuration and configuring the control mechanism with a new correct combination may be partially or substantially automated.

It will be appreciated that where a locker system has a central controller that is physically remote from the locker system, the locker system may include one or more sub-controllers for mediating communications between the central controller and the locker system.

As can be seen in FIGS. 7 and 8, a secure drop-box 744, 844 forms part of the exemplary locker system 700, 800, and the motor vehicle key 204 (not shown in FIGS. 7 and 8) may be received in the secure drop-box 744, 844 before performing service and hence before securing the motor vehicle key 104 in a compartment 708, 808 and setting the combination. Additionally, if a customer has been provided with a “loaner” motor vehicle to use while service is being performed, the motor vehicle key for the “loaner” motor vehicle may be deposited in the secure drop-box 744, 844 by the authorized motor vehicle retriever when collecting the motor vehicle key for the motor vehicle that was being serviced. The locker systems 700, 800 may also be provided with private access openings in a manner analogous to that described above.

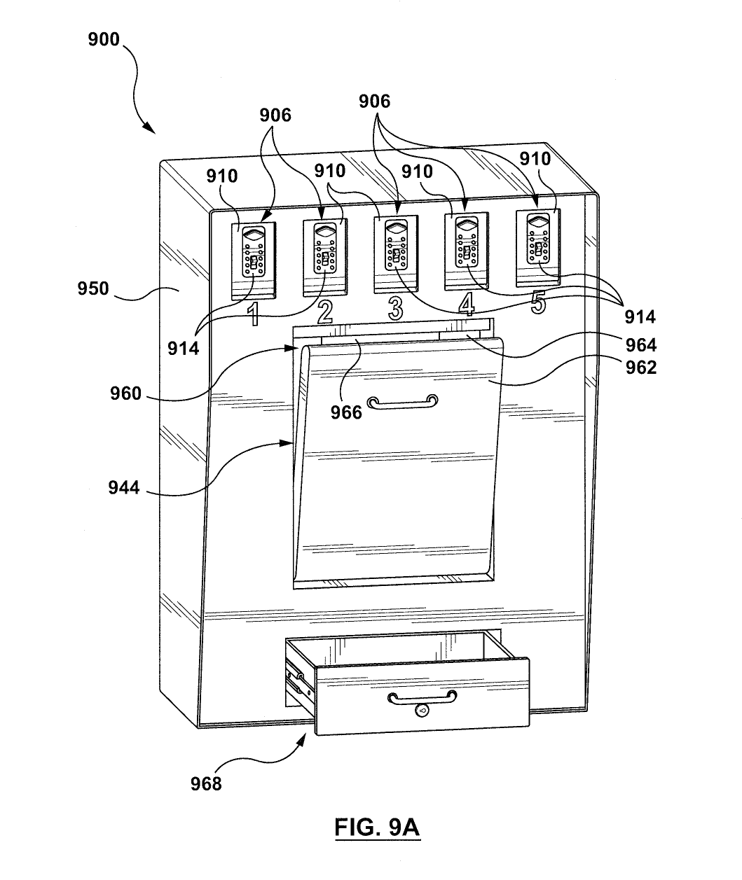

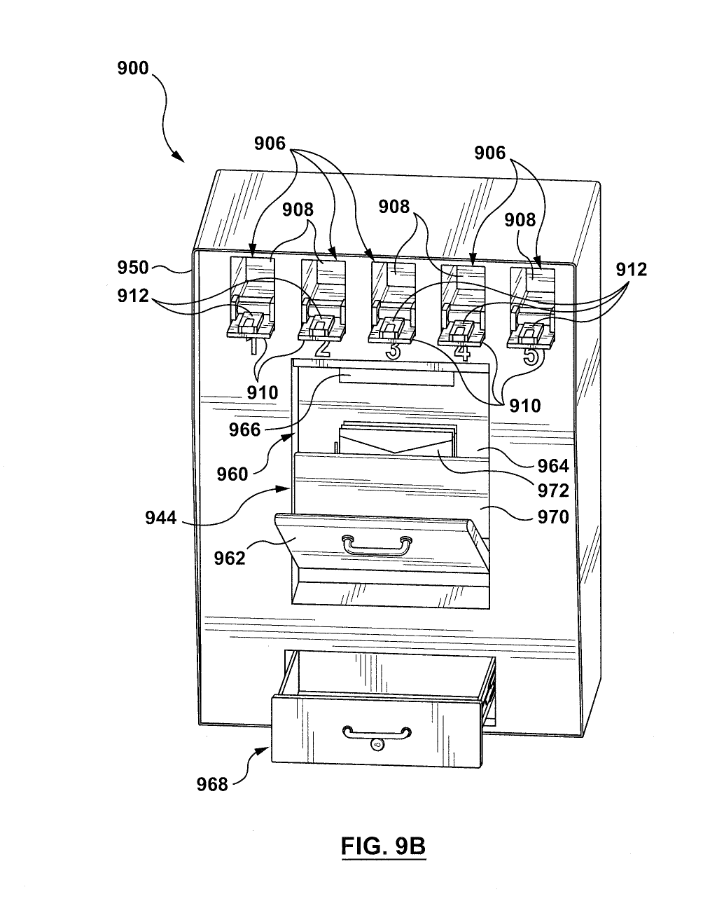

FIGS. 9A and 9B show a locker system 900 comprising a housing 950 which includes a plurality of individual mechanical combination safes 906. Each of the safes 906 has a compartment 908 (FIG. 9B), closure 910, locking mechanism 912 (FIG. 9B) and combination-activated control mechanism 914 (FIG. 9A). In the illustrated embodiment, the compartments 908 form part of the housing 950, and the closure 910, locking mechanism 912 (FIG. 9B) and combination-activated control mechanism 914 (FIG. 9A) are provided by way of faceplates each incorporating a mechanical lock which permits a combination to be mechanically set and reset. In the illustrated embodiment, the faceplates with mechanical locks are those offered as “AccessPoint TouchPoint Lock with Faceplate” (Model No. 001827) by Kidde, a division of United Technologies Corporation, having an address at 1 Financial Plaza, Hartford, Conn. U.S.A. 06101. The locker system 900 further comprises a secure drop-box 944. The secure drop-box 944 comprises a main opening 960 (best seen in FIG. 9B) and a pivoting door 962 for selectively covering the main opening 960. Within the main opening 960, a cover plate 964 obstructs access to the interior of the housing except for an envelope slot 966 which is in vertical registration with a sliding lockable drawer 968. An envelope tray 970 (FIG. 9B) is secured to the main cover plate to hold a plurality of envelopes 972 (FIG. 9B). When the door 962 is open, as shown in FIG. 9B, the envelope tray 970 and envelope slot 966 are exposed, and a user can take an envelope 972 from the envelope tray 97 and use the inside of the door 962 as a writing surface to write his or her details on the envelope 972. The user can then seal the motor vehicle key inside the envelope 972 and deposit the envelope 972 in the envelope slot 966. The envelope 972, with the motor vehicle key inside, will fall into the lockable drawer 968. The door 962, when closed, protects the envelope tray 970 and envelope slot 966 from the elements (in FIG. 9A, the door 962 is shown almost closed but slightly ajar for purposes of illustration). As such, an authorized motor vehicle retriever can use the secure drop-box 944 to drop off the motor vehicle key, which can then be retrieved by a staff member by using a key or combination to unlock the sliding lockable drawer 968 and slide the sliding lockable drawer 968 outward. Once service has been completed, the motor vehicle key can be locked in the compartment 908 of one of the safes 906 for later retrieval by the authorized motor vehicle retriever. The number of the relevant safe 906 can be communicated to the authorized motor vehicle retriever in the manner described above. The structure of the secure drop-box 944 shown in FIGS. 9A and 9B is merely exemplary and is provided by way of illustration; other types of secure drop-boxes may also be used.

Certain currently preferred embodiments have been described by way of example. It will be apparent to persons skilled in the art that a number of variations and modifications can be made without departing from the scope of the claims.

What is claimed is:

1. A method for transferring a motor vehicle key to an authorized motor vehicle retriever, the method comprising the steps of:
(a) placing the motor vehicle key inside a compartment of a lockable container, wherein the lockable container has, for each compartment:
a closure, the closure being movable between:
a closed configuration obstructing public access to the compartment; and
an open configuration permitting public access to the compartment;
a locking mechanism acting between the container and the closure for selectively locking the closure in the closed configuration; and
a combination-activated control mechanism coupled to the locking mechanism for controlling locking and unlocking thereof;
the control mechanism arranged to unlock the locking mechanism in response to entry of a correct combination and to maintain the locking mechanism locked in response to entry of an incorrect combination; and
the control mechanism being selectively reconfigurable with a plurality of correct combinations;
(b) using the locking mechanism to lock the closure in the closed configuration; and
(c) configuring the control mechanism with a new correct combination;
wherein at least step (a) is carried out other than by the authorized motor vehicle retriever; and
wherein steps (a), (b) and (c) may be carried out in any order.

2. The method of claim 1, further comprising a step of, either before or after any one of steps (a), (b) and (c):
(d) communicating the new correct combination to the authorized motor vehicle retriever,
wherein step (d) is carried out other than the by the authorized motor vehicle retriever.

3. The method of claim 2, wherein communicating the new combination to the authorized motor vehicle retriever is carried out by at least one of text message, e-mail message, telephone, non-electronic written communication and presentation on a website.

4. The method of claim 1, wherein the control mechanism is a mechanical control mechanism.

5. The method of claim 1, wherein the control mechanism is an electronic control mechanism.

6. The method of claim 5, wherein:
the compartment is one of a plurality of individually lockable compartments in a locker system; and
configuring the respective control mechanism with a new combination is carried out using a central controller coupled to the locker system.

7. The method of claim 6, wherein the central controller is physically integrated with the locker system.

8. The method of claim 6, wherein the central controller is physically remote from the locker system.

9. The method of claim 5, further comprising:
prior to steps (a), (b) and (c), receiving the motor vehicle key in a secure drop-box forming part of the locker system.

10. The method of claim 1, wherein the motor vehicle key is placed inside the compartment through a private access opening.

11. A method for making a motor vehicle key available to an authorized motor vehicle retriever, the method comprising the steps of:
(i) securing the motor vehicle key in a lockbox; and
(ii) setting a combination for opening the lockbox;
wherein at least step (i) is carried out other than by the authorized motor vehicle retriever; and
wherein steps (i) and (ii) are performed in any order.

12. The method of claim 11, further comprising a step of, either before or after any one of steps (i) and (ii):
(iii) communicating the combination to the authorized motor vehicle retriever;
wherein step (iii) is carried out other than by the authorized motor vehicle retriever.

13. The method of claim 12, wherein communicating the combination to the authorized motor vehicle retriever is carried out by at least one of text message, e-mail message, telephone, non-electronic written communication and presentation on a website.

14. The method of claim 11, wherein the lockbox is a mechanically-controlled lockbox.

15. The method of claim 11, wherein the lockbox is an electronically-controlled lockbox.

16. The method of claim 15, wherein:
the lockbox is one of a plurality of lockboxes in a locker system; and
setting a combination for opening the lockbox is carried out using a central controller coupled to the locker system.

17. The method of claim 16, wherein the central controller is physically integrated with the locker system.

18. The method of claim 16, wherein the central controller is physically remote from the locker system.

19. The method of claim 15, further comprising:
prior to steps (i) and (ii), receiving the motor vehicle key in a secure drop-box forming part of the locker system.

20. The method of claim 11, wherein securing the motor vehicle key in the lockbox comprises placing the motor vehicle key inside the lockbox through a private access opening.

21. A method for handling a motor vehicle key used to service a motor vehicle, the method comprising:
(a) receiving a motor vehicle;
(b) receiving a motor vehicle key for the motor vehicle;
(c) using the motor vehicle key to perform service on the motor vehicle;
(d) making a combination-controlled lockbox accessible to an authorized motor vehicle retriever for the motor vehicle by setting a combination for the lockbox; and
(e) after performing service on the motor vehicle, securing the motor vehicle key in the lockbox;
wherein, after the step of securing the motor vehicle key in the lockbox, the motor vehicle key is available to the authorized motor vehicle retriever for the motor vehicle by use of the combination; and
wherein step (d) is performed in any order relative to steps (a), (b), (c) and (e).

22. The method of claim 21, wherein making a combination-controlled lockbox accessible to the authorized motor vehicle retriever for the motor vehicle by setting a combination for the lockbox comprises setting the combination to a value provided by the authorized motor vehicle retriever.

23. The method of claim 21, wherein making a combination-controlled lockbox accessible to the authorized motor vehicle retriever for the motor vehicle by setting a combination for the lockbox comprises communicating the combination to the authorized motor vehicle retriever.

24. The method of claim 21, wherein making a combination-controlled lockbox accessible to the authorized motor vehicle retriever for the motor vehicle by setting a combination for the lockbox is carried out before securing the motor vehicle key in the lockbox.

25. The method of claim 21, wherein making a combination-controlled lockbox accessible to the authorized motor vehicle retriever for the motor vehicle by setting a combination for the lockbox is carried out after securing the motor vehicle key in the lockbox.
